(19) United States
(12) Patent Application Publication
(10) Pub. No.: US 2026/0127146 A1
(43) Pub. Date: May 7, 2026

(54) ONLINE EVOLUTION METHOD AND APPARATUS FOR EXECUTION PLAN, DEVICE, AND STORAGE MEDIUM

(71) Applicant: BEIJING OCEANBASE TECHNOLOGY CO., LTD., Beijing (CN)

(72) Inventors: Yifei TIAN, Hangzhou (CN); Guoping Wang, Hangzhou (CN); Yi Xiao, Hangzhou (CN); Peng Zeng, Hangzhou (CN)

(21) Appl. No.: 19/437,099

(22) Filed: Dec. 30, 2025

Related U.S. Application Data
(63) Continuation of application No. PCT/CN2024/108523, filed on Jul. 30, 2024.

(30) Foreign Application Priority Data
Aug. 18, 2023 (CN) 202311049133.3

(51) Int. Cl. G06F 16/21; G06F 11/34

(52) U.S. Cl. CPC G06F 16/213; G06F 11/3409; G06F 2201/80

(57) ABSTRACT

This specification provides an online evolution method and apparatus for an execution plan, a device, and a storage medium. The method includes: In response to a received current database request including a target database statement, an evolution task is obtained from a plan cache corresponding to the target database statement. A type of an execution plan actually used by the database request is selected, so that an accumulative quantity of execution times of each type of execution plan in an implementation process of the evolution task is positively correlated with performance of each type of execution plan. After the evolution task ends, if it is determined that performance of a current execution plan of an evolution type is better than performance of an execution plan of a baseline type, the execution plan of the evolution type is changed into an execution plan of the baseline type corresponding to the target database statement.

### TECHNICAL FIELD

This specification relates to the field of database processing technologies, and in particular, to an online evolution method and apparatus for an execution plan, a device, and a storage medium.

### BACKGROUND

During execution of a database statement, a typical process includes: generating an execution plan corresponding to the database statement, and executing the generated execution plan. The same database statement may have different execution plans, and there are performance differences between different execution plans. To prevent an execution plan with a good performance from being replaced by an execution plan with a poor performance, in a related technology, a database plan management function is introduced into some databases to resolve a problem of plan rollback. A core idea of the database plan management function is to always execute an execution plan used in the past instead of executing a new execution plan.

### SUMMARY

The applicants recognize that the database plan management function of the existing database only records a new execution plan when the new execution plan appears. If a user does not actively trigger an evolution task to verify performance of the new execution plan, the database will never use the new execution plan, even if the performance of the new execution plan is better than that of the execution plan that has been executed previously.

This specification provides an online evolution method and apparatus for an execution plan, a device, and a storage medium.

According to a first aspect of implementations of this specification, an online evolution method for an execution plan is provided. The method includes: in response to a received current database request including a target database statement, obtaining an evolution task from a plan cache corresponding to the target database statement, where the evolution task is used to compare performance of an execution plan of an evolution type with performance of an execution plan of a baseline type, the execution plan of the evolution type is an unverified execution plan corresponding to the target database statement, and the execution plan of the baseline type is a verified execution plan corresponding to the target database statement; selecting a type of an execution plan actually used by the current database request, so that an accumulative quantity of execution times of each type of execution plan in an implementation process of the evolution task is positively correlated with performance of each type of execution plan; and after the evolution task ends, if it is determined that the performance of the execution plan of the evolution type is better than the performance of the execution plan of the baseline type, changing the execution plan of the evolution type into an execution plan of the baseline type corresponding to the target database statement.

According to a second aspect of implementations of this specification, an online evolution apparatus for an execution plan is provided. The apparatus includes: an obtaining module, configured to: in response to a received current database request including a target database statement, obtain an evolution task from a plan cache corresponding to the target database statement, where the evolution task is used to compare performance of an execution plan of an evolution type with performance of an execution plan of a baseline type, the execution plan of the evolution type is an unverified execution plan corresponding to the target database statement, and the execution plan of the baseline type is a verified execution plan corresponding to the target database statement; a selection module, configured to select a type of an execution plan actually used by the current database request, so that an accumulative quantity of execution times of each type of execution plan in an implementation process of the evolution task is positively correlated with performance of each type of execution plan; and a determining module, configured to: after the evolution task ends, if it is determined that the performance of the execution plan of the evolution type is better than the performance of the execution plan of the baseline type, change the execution plan of the evolution type into an execution plan of the baseline type corresponding to the target database statement.

According to a third aspect of implementations of this specification, an electronic device is provided. The electronic device includes: a processor; and a memory configured to store a processor-executable instruction, where the processor runs the executable instruction to implement the online evolution method for an execution plan according to any one of the foregoing aspects.

According to a fourth aspect of one or more implementations of this specification, a computer-readable storage medium is provided, where the computer-readable storage medium stores a computer instruction, and the instruction is executed by a processor to implement the steps of the online evolution method for an execution plan according to any one of the foregoing aspects.

The technical solutions provided in the implementations of this specification may include the following beneficial effects: In the implementations of this specification, a corresponding evolution task is recorded in a plan cache corresponding to a target database statement, so that when a database request including the target database statement is received, an execution plan of a baseline type or an evolution type may be triggered and executed based on the evolution task, so as to compare performance of the execution plan of the baseline type with performance of the execution plan of the evolution type, thereby implementing automatic evolution of the execution plan. Because the evolution task is processed for a real database request in an implementation process, instead of being additionally processed through simulation, no additional performance consumption is caused. In addition, a type of an execution plan is dynamically selected for a received database request including the target database statement, so as to ensure that an accumulative quantity of execution times of each type of execution plan in the implementation process of the evolution task is positively correlated with performance of each type of execution plan, so that the execution plan with better performance is executed for more times. If the execution plan of the evolution type has relatively poorer performance, impact of plan rollback caused by the execution plan of the evolution type may be weakened as much as possible. If the execution plan of the evolution type has relatively better performance, execution efficiency of the evolution task can be improved, and evolution can be accelerated, thereby further helping improve overall execution efficiency of the target database statement.

It should be understood that the foregoing general description and the following detailed description are merely examples and explanations, and should not limit this specification.

### BRIEF DESCRIPTION OF DRAWINGS

The accompanying drawings, which are incorporated in and form a part of this specification, illustrate some implementations consistent with this specification and, together with this specification, serve to explain the principles of this specification.

FIG. 1 is a flowchart of an online evolution method for an execution plan according to an example implementation of this specification;

FIG. 2 is a flowchart of generating an evolution task according to an example implementation of this specification;

FIG. 3 is a flowchart of an evolution task according to an example implementation of this specification;

FIG. 4 is a block diagram of an online evolution apparatus for an execution plan according to an example implementation of this specification; and

FIG. 5 is a schematic structural diagram of an electronic device according to an example implementation of this specification.

### DESCRIPTION OF IMPLEMENTATIONS

Some example implementations are described in detail here, and examples of the example implementations are presented in the accompanying drawings. When the following description relates to the accompanying drawings, unless specified otherwise, same numbers in different accompanying drawings represent same or similar elements. Implementations described in the following example implementations do not represent all implementations consistent with this specification. On the contrary, the implementations are merely examples of apparatuses and methods that are described in the appended claims in detail and consistent with some aspects of this specification.

The terms used in this specification are merely for illustrating specific implementations, and are not intended to limit this specification. The terms “a” and “the” of singular forms used in this specification and the appended claims are also intended to include plural forms, unless otherwise specified in the context clearly. It should be further understood that the term “and/or” used in this specification indicates and includes any or all possible combinations of one or more associated listed items.

It should be understood that although terms “first”, “second”, “third”, and the like may be used in this specification to describe various types of information, the information should not be limited by these terms. These terms are used merely to differentiate information of the same type. For example, without departing from the scope of this specification, first information may also be referred to as second information, and similarly, the second information may also be referred to as the first information. Depending on the context, for example, the word “if” used here may be explained as “while”, “when”, or “in response to determining”.

A database is an ordered set of structured information or data, and the ordered set is usually controlled by a database management system (DBMS). In various scenarios, data, database management systems, and associated applications are collectively referred to as database systems, which are usually referred to as databases for short. When a user needs to perform an operation on a database, for example, accessing, managing, modifying, updating, controlling, or organizing data, a database statement is usually used for implementing the operation. For example, a database statement complying with an SQL (structured query language) standard is used in a relational database, which may also be referred to as an SQL statement.

The database statement used by the user may indicate a database table that needs to be operated, and an operator that needs to be used for the database table. The operator is used to indicate an operation to be performed for a corresponding database table. However, the database statement can only express “what the user wants” to the database, but cannot directly express, to the database, “how to obtain” the result. In addition, there are a plurality of possible connection sequences between database tables during implementation of a connection operation, and there are a plurality of specific implementation algorithms for each operator. Therefore, there may be many equivalent methods for obtaining the result for one database statement, and a query optimizer in the database needs to determine a method for obtaining the result. Here, each method for obtaining the result is referred to as one “execution plan”. In other words, an execution plan may refer to a method used by a database to access data.

In some practice, when generating a new execution plan for a database request, the database always directly executes the new execution plan. As a result, when performance of the new execution plan is poorer than performance of a previous execution plan, plan rollback is caused, affecting execution efficiency of a subsequent database statement.

In some practice, a database plan management function that is evolved offline is used for a common database. A general procedure includes the following actions. After the database generates a new execution plan for the same database request, the new execution plan is recorded. Subsequently, the user actively initiates an evolution task. The database receives the database request in the backend through simulation, executes the new execution plan and the previously used execution plan separately, and determines, through comparison, which of the two execution plans has better performance. In this offline evolution processing manner, an execution process of an evolution task causes additional resource consumption to implement simulation processing on the database request. In addition, the new execution plan is not used to execute the database request actually received by the database, but the previous execution plan is still executed. Therefore, even if the new execution plan has higher execution efficiency, the new execution plan cannot immediately take effect, thereby reducing the processing efficiency of the real database request.

In some implementations, this specification provides an online evolution method for an execution plan, which improves efficiency of an evolution task and implements automatic execution of an optimal plan while avoiding plan rollback, thereby improving execution efficiency of a subsequent database statement.

Some implementations of this specification are described in detail below.

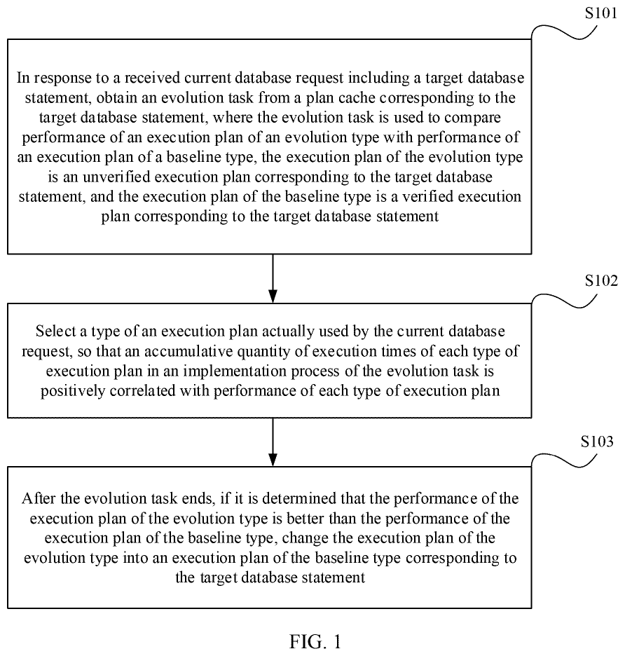

FIG. 1 is a flowchart of an online evolution method for an execution plan according to an example implementation of this specification. As shown in FIG. 1, the method includes the following actions S101 to S103.

S101: In response to a received current database request including a target database statement, obtain an evolution task from a plan cache corresponding to the target database statement, where the evolution task is used to compare performance of an execution plan of an evolution type with performance of an execution plan of a baseline type, the execution plan of the evolution type is an unverified execution plan corresponding to the target database statement, and the execution plan of the baseline type is a verified execution plan corresponding to the target database statement.

A user-side device sends the database request including the database statement, and a database-side device receives and responds to the database request. In an implementation of this specification, the database-side device may be a device used to deploy a database. After receiving a database request, the database-side device directly executes an execution plan corresponding to a database statement locally. Alternatively or additionally, the database-side device may be used to connect between the user-side device and a device on which a database is deployed. After receiving a database request from the user-side device, the database-side device sends the request to the device on which a database is deployed. Finally, the device on which a database is deployed executes an execution plan corresponding to a database statement.

The database-side device stores a plan cache corresponding to the database statement, and the plan cache may include the plan cache corresponding to the target database statement. Different database statements may respectively correspond to different plan caches. A plan cache is used to record an execution plan corresponding to a corresponding database statement. The execution plan may be presented in a plurality of forms, for example, a generated execution plan of a baseline type, or an evolution task in an implementation of this specification. The evolution task further relates to an execution plan of a baseline type and an execution plan of an evolution type. In some implementations, the plan cache may be considered as a cache for an execution plan, so that when processing the database statement in the database request, the database-side device may directly read the execution plan in the plan cache for execution, without temporarily generating an execution plan.

Content stored in the plan cache is dynamically changed. When the database-side device receives the database request including the target database statement for the first time, the plan cache corresponding to the target database statement certainly does not include any execution plan. The database-side device can temporarily generate an execution plan for the target database statement. Because the processing is performed for the first time, the execution plan of the baseline type corresponding to the target database statement does not exist. Therefore, the temporarily generated execution plan is directly used as the execution plan of the baseline type corresponding to the target database statement, and the execution plan is stored in the plan cache.

The execution plan of the baseline type stored in the plan cache also complies with some processing mechanisms of the “cache”, such as an aging mechanism. For example, when the execution plan of the baseline type stored in the plan cache is not executed within a preset duration, the execution plan of the baseline type is deleted from the plan cache, thereby saving cache space of the database-side device and improving cache utilization. In addition to the foregoing aging mechanism, some database changes or the like may also cause the execution plan of the baseline type in the plan cache to be eliminated. For example, the changes may include creation of an index, which is not limited in this specification.

Certainly, even if the execution plan of the baseline type in the plan cache is deleted, it should also be considered that the target database statement has a corresponding execution plan of the baseline type, but in an example execution process, the execution plan of the baseline type is temporarily generated and cannot be read from the plan cache. Therefore, when the database-side device subsequently receives the database request including the target database statement, if the execution plan of the baseline type is read from the plan cache corresponding to the target database statement, the read execution plan is directly executed. If the execution plan of the baseline type does not exist in the plan cache corresponding to the target database statement, an execution plan may be temporarily generated, and it is determined whether the temporarily generated execution plan is consistent with the execution plan of the baseline type corresponding to the target database statement. If the temporarily generated execution plan is consistent with the execution plan of the baseline type, it indicates that the temporarily generated execution plan is an execution plan of the baseline type; otherwise, it indicates that the temporarily generated execution plan is an execution plan of the evolution type. In an implementation, when a database change such as an index is created, the execution plan of the evolution type rather than the original execution plan of the baseline type is generated for the target database statement. For the generated execution plan of the evolution type, the database-side device further generates an evolution task, so as to evolve for the execution plan of the target database statement.

In an implementation of this specification, the evolution task is used to compare execution performance of the execution plan of the evolution type with execution performance of the execution plan of the baseline type. When the database generates a new execution plan for a database request, the generated execution plan is an execution plan of the evolution type, and the execution plan of the evolution type is an unverified execution plan corresponding to the target database statement. However, the execution plan used before the database generates the new execution plan is an execution plan of the baseline type, and the execution plan of the baseline type is a verified execution plan corresponding to the target database statement.

In an implementation of this specification, the generated new execution plan corresponding to the target database statement may be verified in two manners. A first manner is that based on a performance comparison result obtained by the evolution task, if the performance of the execution plan of the evolution type is better than the performance of the execution plan of the baseline type, the performance of the execution plan of the evolution type is verified, so that the execution plan of the evolution type may be changed into an execution plan of the baseline type. A second manner is that when the target database statement does not have the corresponding execution plan of the baseline type, because there is no comparable execution plan of the baseline type, the execution plan of the evolution type may be directly considered as having been verified, and therefore may be changed into an execution plan of the baseline type. As described herein, in some implementations, after receiving the database request including the target database statement for the first time, the database-side device considers the new execution plan as an execution plan of the baseline type based on the second case.

In addition, the execution plan of the baseline type corresponding to the target database statement may also have an elimination mechanism. For example, if any execution plan of the baseline type corresponding to the target database statement has not been used for a duration (“unused duration”) that reaches a preset duration threshold, it indicates that the execution plan of the baseline type has low popularity (possibly due to insufficient performance or the like). To prevent storage space of the database-side device from being occupied (used to record the execution plan of the baseline type corresponding to the target database statement), the execution plan of the baseline type may be deleted. If all execution plans of the baseline type corresponding to the target database statement are deleted, the target database statement is restored to a state in which there is no corresponding execution plan of the baseline type. It can be learned that the target database statement may have one or more execution plans of the baseline type at the same time. For example, an execution plan 1 of the baseline type originally exists, and an execution plan of the evolution type becomes an execution plan 2 of the baseline type after being verified through an evolution task. Similarly, there may be more execution plans of the baseline type. The execution plan 1 of the baseline type is used as an example. If the execution plan 1 of the baseline type is not used for a long time, the execution plan 1 of the baseline type may be deleted based on the foregoing elimination mechanism, so that the target database statement has only a frequently used execution plan of the baseline type, that is, the execution plan 2 of the baseline type. In this way, the execution plan of the baseline type is eliminated, and a transition period of a preset duration threshold is provided for the execution plan 1 of the baseline type, so that when the execution plan 1 of the baseline type is temporarily switched back for use, there is no need to perform an evolution task again, thereby reducing resource consumption.

After generating an evolution task corresponding to a database statement, the database-side device stores the evolution task in a plan cache corresponding to the database statement. In some implementation, when a current database request is received, a plan cache corresponding to a target database statement already includes a corresponding evolution task, which indicates that the database-side device has previously generated an evolution task for the target database statement. The database-side device may generate an evolution task corresponding to the target database statement based on a previously received historical database request including the target database statement, and store the evolution task in a corresponding plan cache. For example, in response to the received historical database request including the target database statement, a plan cache corresponding to the target database statement is queried, and when the plan cache does not include a corresponding evolution task and a generated execution plan, a database statement execution plan corresponding to the target database statement is generated. The plan cache includes either a generated execution plan or an evolution task, and does not include both of the generated execution plan and the evolution task. If the generated database statement execution plan is an execution plan of the evolution type, the evolution task is generated and cached into the plan cache corresponding to the target database statement. In a processing procedure for the historical database request, if the plan cache corresponding to the target database statement includes an evolution task, the evolution task is directly executed without triggering generation of a new evolution task. If the plan cache corresponding to the target database statement includes a generated execution plan, the execution plan is directly executed without triggering generation of a new execution plan or evolution task. This is consistent with the foregoing process of generating an evolution task. In some implementations, a new execution plan is generated for the target database statement only when the plan cache corresponding to the target database statement includes neither an evolution task nor a generated execution plan. In addition, generation of an evolution task is triggered only when the new execution plan is an execution plan of an evolution type.

A person skilled in the art should understand that, in an implementation of this specification, the current database request and the historical database request are merely relative concepts, so as to help distinguish a sequence of receiving different database requests. For example, the database-side device first receives the historical database request, generates an evolution task based on the historical database request, and then receives the current database request.

In an example implementation, the current database request may not have a corresponding historical database request, or the historical database request may not be used to generate an evolution task. For example, in response to the received current database request including the target database statement, a plan cache corresponding to the target database statement is queried, and when the plan cache does not include a corresponding evolution task and a generated execution plan, a database statement execution plan corresponding to the target database statement is generated, which is equivalent to the foregoing new execution plan or another similar concept.

In some cases, there is an execution plan of a baseline type corresponding to the target database statement, e.g., it indicates that the current database request includes the target database statement is not received by the database-side device for the first time, and an execution plan of the baseline type stored in the plan cache may be deleted for an aging mechanism or another reason. Therefore, the foregoing database statement execution plan may be temporarily generated. In this case, the generated database statement execution plan may be compared with the execution plan of the baseline type. When a comparison result is that the two execution plans are consistent, it indicates that the generated database statement execution plan is an execution plan of the baseline type. In this case, the database statement execution plan is executed and cached into the plan cache corresponding to the target database statement. Hash values of the generated database statement execution plan and the execution plan of the baseline type may be compared. If the hash values are consistent, it indicates that a comparison result is that the two execution plans are consistent; otherwise, the two execution plans are inconsistent. Certainly, in addition to the comparison based on the hash value, the two execution plans may be compared in any other manner, which are all included in the scope of the specification and the specification is not limited by any specific one of such comparison approaches.

[symbol]

In some cases, there is no execution plan of a baseline type corresponding to the target database statement, e.g., it indicates that the current database request that includes the target database statement is received by a for the first time, or t the database request that includes the target database statement is not received for the first time, but the execution plan of the baseline type corresponding to the target database statement has been deleted for an elimination mechanism or another reason. Therefore, the foregoing database statement execution plan needs to be temporarily generated. In this case, the generated database statement execution plan may be added to the execution plan of the baseline type, the database statement execution plan may be executed, and the database statement execution plan may be cached into the plan cache corresponding to the target database statement.

S102: Select a type of an execution plan actually used by the current database request, so that an accumulative quantity of execution times of each type of execution plan in an implementation process of the evolution task is positively correlated with performance of each type of execution plan.

As described above, the type of the execution plan includes the baseline type and the evolution type. Therefore, the execution plan selected for the current database request is either an execution plan of the evolution type or an execution plan of the baseline type. In the implementation process of the evolution task corresponding to the target database statement, each time one database request including the target database statement is received, the evolution task is triggered to be executed for one round, and an execution plan of the evolution type or an execution plan of the baseline type is selected and executed once for each round.

In an implementation of this specification, a type of an execution plan to be selected for each round may be determined in any manner, as long as it is ensured that overall statistical data can meet a condition that the accumulative quantity of execution times of each type of execution plan is positively correlated with the performance of each type of execution plan. A manner of selecting the execution plan is not limited in this specification.

An accumulative quantity of execution times of each execution plan type is set to be positively correlated with performance of each execution plan type, so that an execution plan type with poorer execution performance has a smaller accumulative quantity of execution times, and an execution plan type with better execution performance has a larger accumulative quantity of execution times, thereby minimizing negative impact caused by an execution plan with poor execution performance, quickly verifying a better execution plan, and improving execution efficiency of an evolution task. If the execution efficiency of the execution plan of the evolution type is relatively higher, it is proved that the performance of the execution plan of the evolution type is relatively better. This implementation of this specification is based on a technical solution of online evolution. To be specific, the type of the execution plan is dynamically selected and practically executed for each received database request including the target database statement. Therefore, when the performance of the execution plan of the evolution type is relatively better, execution efficiency of some database requests that include the target database statement and that are executed by selecting the execution plan of the evolution type can be improved. In addition, in the implementation process of the evolution task, the execution plan of the evolution type is more likely to be selected, so that overall execution efficiency of the database request can be greatly improved. If the execution efficiency of the execution plan of the evolution type is relatively lower, it is proved that the performance of the execution plan of the baseline type is relatively better. Based on a limitation that the accumulative quantity of execution times of the execution plan type is positively correlated with the performance of the execution plan type, the accumulative quantity of execution times of the execution plan of the evolution type in the overall implementation process of the evolution task is reduced, thereby minimizing negative impact caused by an execution plan with poor performance, ensuring that plan rollback is nearly not perceived, quickly verifying a better execution plan when there are only a small quantity of controllable plan rollbacks, and improving execution efficiency of an evolution task.

In an example implementation, the implementation process of the evolution task may include a plurality of stages. In an initial stage, a quantity of execution times of the execution plan of the evolution type is the same as a quantity of execution times of the execution plan of the baseline type, so that the execution plan of the evolution type and the execution plan of the baseline type can be visually compared to determine execution efficiency of the two execution plans in the initial stage. The quantity of execution times of each type of execution plan may be any value. For example, each type of execution plan is executed for 10 times, or less or more times, which is not limited in this specification.

In any other stage other than the initial stage, the quantity of execution times of each type of execution plan is negatively correlated with a proportion of average execution duration of each type of execution plan in at least one stage before the any other stage. Assuming that there are a total of N stages, where N>1, and is a positive integer, stages other than the initial stage include a second stage to an Nth stage. Certainly, if N=2, the stages other than the initial stage include only the second stage. A value of N is not limited in this specification.

For any other stage, an ith stage (1<i≤N, where i is a positive integer) is used as an example. All stages before the ith stage include a first stage (namely, the initial stage) to an (i−1)th stage. In this case, at least one stage before the ith stage is at least one stage from the first stage to the (i−1)th stage. For example, when i=2, at least one stage before the second stage is the first stage. For another example, when i=3, at least one stage before the third stage may be the first stage, may be the second stage, or may include both the first stage and the second stage. The rest are deduced by analogy, and are not listed one by one here. Certainly, regardless of how the at least one stage is selected, it should be ensured that the same stage is selected for each type of execution plan, so that average execution duration of corresponding calculation is comparable.

Average execution duration of each type of execution plan in at least one stage before any other stage may be a ratio of total execution duration of the type of execution plan in the at least one stage to a quantity of execution times, e.g., average duration of executing the type of execution plan once in the at least one stage. A person skilled in the art should understand that, when average execution duration of a type of execution plan in at least one stage before the any other stage is longer, it indicates that execution efficiency of the type of execution plan is lower, and when the average execution duration is shorter, it indicates that the execution efficiency of the type of execution plan is higher. Therefore, a quantity of execution times of each type of execution plan is assumed to be negatively correlated with a proportion of average execution duration of each type of execution plan in at least one stage before the any other stage, so that an execution plan with relatively longer average execution duration and relatively lower execution efficiency is executed for relatively less times in the any other stage, and an execution plan with relatively shorter average execution duration and relatively higher execution efficiency is executed for relatively more times in the any other stage. This ensures that a probability of selecting and executing an execution plan with good performance continuously increases, and a probability of selecting and executing an execution plan with poor performance continuously decreases, thereby helping alleviate impact of plan rollback caused by the execution plan with poor performance, and improve execution efficiency of an evolution task.

Certainly, the evolution task may not be divided into the foregoing plurality of stages. This is equivalent to including only one stage. In this case, in the implementation process of the evolution task, execution efficiency of each type of execution plan may be dynamically accumulated, for example, average execution duration of each type of execution plan is accumulated, and each type of execution plan may be selected and executed based on the execution efficiency of each type of execution plan. This ensures that in the overall implementation process of the evolution task, an accumulative quantity of execution times of each type of execution plan is positively correlated with performance of each type of execution plan. To be specific, poorer execution performance indicates a smaller accumulative quantity of execution times, and better execution performance indicates a larger accumulative quantity of execution times.

In an example implementation, after the execution plan selected for the current database request is completed, it is determined whether the evolution task meets a predefined evolution end condition, where the evolution end condition may include that a quantity of evolution times reaches a threshold and/or evolution duration reaches a threshold. Certainly, another evolution end condition may alternatively be used, which is not limited in this specification.

S103: After the evolution task ends, if it is determined that the performance of the execution plan of the evolution type is better than the performance of the execution plan of the baseline type, change the execution plan of the evolution type into an execution plan of the baseline type corresponding to the target database statement.

In an example implementation, average execution duration of the execution plan of the evolution type and average execution duration of the execution plan of the baseline type are separately determined based on an execution status of the evolution task; and either the execution plan of the evolution type or the execution plan of the baseline type, whichever has relatively shorter corresponding average execution duration, is determined as the execution plan with relatively better performance. For example, it is assumed that average execution duration of the execution plan of the evolution type for each execution time in the overall implementation process of the evolution task is T1, and average execution duration of the execution plan of the baseline type for each execution time in the overall implementation process of the evolution task is T2. Therefore, when T1<T2, it indicates that the execution efficiency of the execution plan of the evolution type is higher than the execution efficiency of the execution plan of the baseline type. In this case, it may be determined that the performance of the execution plan of the evolution type is relatively better, and the performance of the execution plan of the baseline type is relatively poorer. When T1>T2, it indicates that the execution efficiency of the execution plan of the baseline type is higher than the execution efficiency of the execution plan of the evolution type. In this case, it may be determined that the performance of the execution plan of the baseline type is relatively better, and the performance of the execution plan of the evolution type is relatively poorer. When T1=T2, it may be determined, based on a predefined processing policy, whether to consider the execution plan of the evolution type as having passed verification.

A performance comparison result is obtained by using an evolution task. If the performance of the execution plan of the evolution type is better than the performance of the execution plan of the baseline type, the performance of the execution plan of the evolution type has been verified, and the execution plan of the evolution type is changed into an execution plan of the baseline type corresponding to the target database statement, and cached into a plan cache corresponding to the target database statement. If the performance of the execution plan of the baseline type is better than the performance of the execution plan of the evolution type, the execution plan of the evolution type with poorer performance is discarded, and the execution plan of the baseline type is cached into the plan cache corresponding to the target database statement. When the database-side device receives the database request including the target database statement again, the database-side device may directly execute an execution plan that is cached in the plan cache corresponding to the target database statement. Performance merits of the execution plan of the evolution type and the execution plan of the baseline type are quickly determined by using the evolution task, and an execution plan with relatively better performance is used as a subsequent execution plan corresponding to the target database statement, thereby improving overall execution efficiency of the target database statement.

In implementations of this specification, a corresponding evolution task is recorded in a plan cache corresponding to a target database statement, so that when a database request including the target database statement is received, an execution plan of a baseline type or an evolution type may be triggered and executed based on the evolution task, so as to compare performance of the execution plan of the baseline type with performance of the execution plan of the evolution type, thereby implementing automatic evolution of the execution plan. Because the evolution task is processed for a real database request in an implementation process, instead of being additionally processed through simulation, no additional performance consumption is caused. In addition, a type of an execution plan is dynamically selected for a received database request including the target database statement, so as to ensure that an accumulative quantity of execution times of each type of execution plan in the implementation process of the evolution task is positively correlated with performance of each type of execution plan, so that the execution plan with better performance is executed for more times. If the execution plan of the evolution type has relatively poorer performance, impact of plan rollback caused by the execution plan of the evolution type may be weakened as much as possible. If the execution plan of the evolution type has relatively better performance, execution efficiency of the evolution task can be improved, and evolution can be accelerated, thereby further helping improve overall execution efficiency of the target database statement.

When the execution plan of the baseline type is better than the execution plan of the evolution type, the execution plan of the evolution type can be eliminated in a timely manner, and impact of plan rollback caused by the execution plan with poor performance is weakened. In addition, when the execution plan of the evolution type is better than the execution plan of the baseline type, the better execution plan can be used in a timely manner, and execution efficiency of some database requests executed by selecting the execution plan of the evolution type can be improved. Finally, when there are only a small quantity of controllable plan rollbacks, a better execution plan is quickly verified, thereby improving execution efficiency of a database statement.

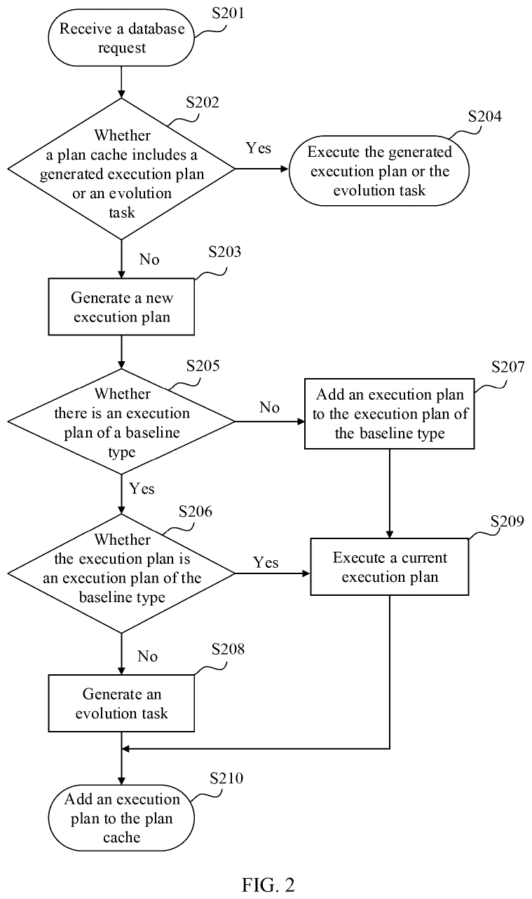

FIG. 2 is a flowchart of generating an evolution task according to an example implementation of this specification. As shown in FIG. 2, the flowchart includes specific steps S201 to S210.
S201: Receive a database request. A database receives a database request that is sent by a user and that includes a target database statement.
S202: Determine whether a plan cache includes a generated execution plan or an evolution task. A plan cache corresponding to the target database statement is queried, and it is determined whether the plan cache includes a generated execution plan or a corresponding evolution task corresponding to the target database request. If no, step S203 is performed. If yes, step S204 is performed.
S203: Generate a new execution plan. If the plan cache corresponding to the target database statement does not include an available execution plan or an evolution task corresponding to the target database request, in this case, the database generates a new database statement execution plan for the database request including the target database statement.
S204: Execute the generated execution plan or the evolution task. If the plan cache corresponding to the target database statement includes the generated execution plan or the evolution task corresponding to the target database request, the corresponding generated execution plan or evolution task is directly executed.
S205: Determine whether there is an execution plan of a baseline type. It is determined whether the target database statement has the execution plan of the baseline type. If yes, step S206 is performed. If no, step S207 is performed.
S206: Determine whether the execution plan is an execution plan of the baseline type. When the target database statement has an execution plan of the baseline type, it is determined whether a new execution plan corresponding to the target database statement is an execution plan of the baseline type. If yes, step S209 is performed. If no, step S208 is performed.
S207. Add an execution plan to the execution plan of the baseline type. When the target database statement does not have an execution plan of the baseline type, the new execution plan corresponding to the target database statement is added to the execution plan of the baseline type, and is used to determine, when subsequently receiving a database request including the target database statement again, and generating a new execution plan, whether the new execution plan is an execution plan of the baseline type.
S208: Generate an evolution task. If the new execution plan corresponding to the target database statement is not an execution plan of the baseline type, the new execution plan is determined to be an execution plan of an evolution type, data of the execution plan of the evolution type and an execution plan of the baseline type with optimal performance is saved, and the execution plan of any one of these types is executed.
S209: Execute a current execution plan. When it is determined that the new execution plan corresponding to the target database statement is an execution plan of the baseline type or is added to the execution plan of the baseline type, the current execution plan is executed, and step 210 is performed.
S210: Add an execution plan to the plan cache. The evolution task that corresponds to the target database request and that is generated in step S208 or the execution plan that corresponds to the target database request and that is generated in step S209 is added to the plan cache corresponding to the target database request.

For an implementation process of the foregoing steps, references are made to an implementation process of corresponding steps in the implementation in FIG. 1, and details are not described here again.

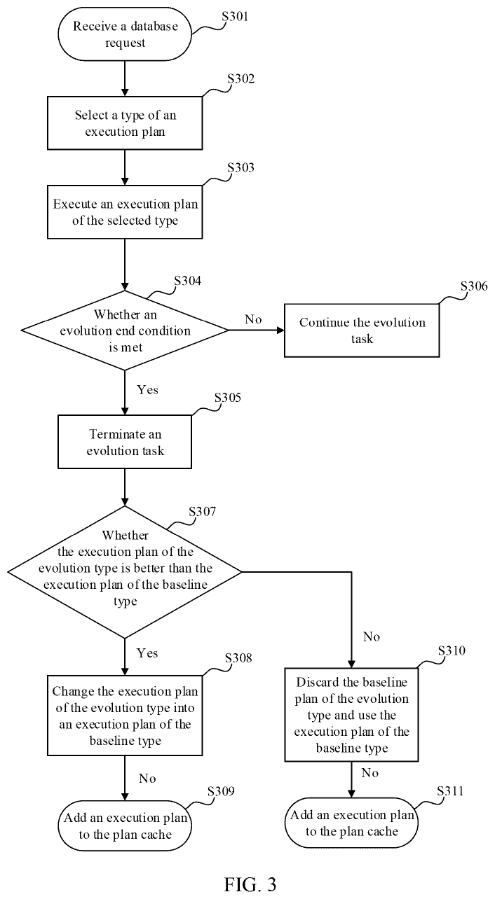

FIG. 3 is a flowchart of an evolution task according to an example implementation of this specification. The flowchart includes specific steps S301 to S311.
S301: Receive a database request. When a current database request including a target database statement is received, and a plan cache corresponding to the target database statement includes an evolution task, the evolution task is obtained.
S302: Select a type of an execution plan. An execution plan of an evolution type or an execution plan of a baseline type is dynamically selected and executed.
S303: Execute an execution plan of the selected type. The execution plan of the selected type is executed and duration of the current execution is recorded.
S304: Determine whether an evolution end condition is met. If the evolution end condition is met, step S305 is performed. If the evolution end condition is not met, step S306 is performed.
S305: Terminate an evolution task. The evolution task is terminated, and the evolution task is deleted from the plan cache corresponding to the target database statement.
S306: Continue the evolution task. Execution of the current database request including the target database statement is completed, but the evolution task is still retained in the plan cache corresponding to the target database statement, so as to be used to receive a database request including the target database statement next time.
S307: Determine whether the execution plan of the evolution type is better than the execution plan of the baseline type. If the execution plan of the evolution type is better than the execution plan of the baseline type, step S308 is performed. If the execution plan of the baseline type is better than the execution plan of the evolution type, step S310 is performed.
S308: Change the execution plan of the evolution type into an execution plan of the baseline type. The execution plan of the evolution type is changed into an execution plan of the baseline type corresponding to the target database statement.
S309: Add an execution plan to the plan cache. The execution plan of the baseline type, into which the execution plan of the evolution type is changed, corresponding to the target database statement is used as the execution plan corresponding to the target database statement and is added to the plan cache corresponding to the target database statement.
S310: Discard the execution plan of the evolution type and use the execution plan of the baseline type.
S311: Add an execution plan to the plan cache. The execution plan of the baseline type is used as the execution plan corresponding to the target database statement and is added to the plan cache corresponding to the target database statement.

For an implementation process of the foregoing steps, references are made to an implementation process of corresponding steps in the implementation in FIG. 1, and details are not described here again.

Corresponding to some implementations of the above-described method, this specification further provides some implementations of an apparatus and a terminal to which the apparatus is applied.

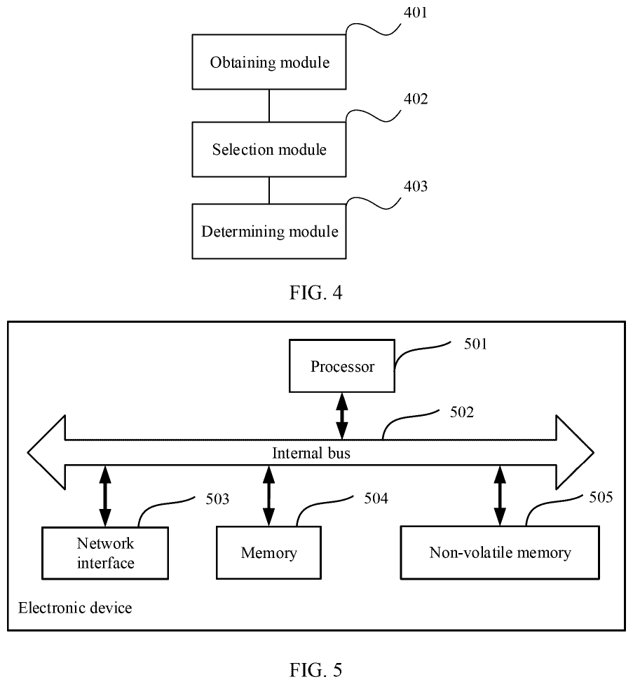

FIG. 4 is a block diagram of an apparatus according to an example implementation of this specification. As shown in FIG. 4, the apparatus includes: an obtaining module 401, configured to: in response to a received current database request including a target database statement, obtain an evolution task from a plan cache corresponding to the target database statement, where the evolution task is used to compare performance of an execution plan of an evolution type with performance of an execution plan of a baseline type, the execution plan of the evolution type is an unverified execution plan corresponding to the target database statement, and the execution plan of the baseline type is a verified execution plan corresponding to the target database statement; a selection module 402, configured to select a type of an execution plan actually used by the database request, so that an accumulative quantity of execution times of each type of execution plan in an implementation process of the evolution task is positively correlated with performance of each type of execution plan; and a determining module 403, configured to: after the evolution task ends, if it is determined that the performance of the current execution plan of the evolution type is better than the performance of the execution plan of the baseline type, change the execution plan of the evolution type into an execution plan of the baseline type corresponding to the target database statement.

For an implementation process of functions and roles of each module in the apparatus, references are made to an implementation process of a corresponding step in the foregoing method, and details are not described here again.

Because some apparatus implementations basically correspond to some method implementations, for related parts, references are made to related descriptions in the method implementations. The described apparatus implementations are merely examples. The modules described as separate parts may or may not be physically separate, and parts displayed as modules may or may not be physical modules, that is, may be located in one position, or may be distributed on a plurality of network modules. Some or all of the modules may be selected based on actual needs to achieve the objectives of the solutions of this specification. A person of ordinary skill in the art can understand and implement the solutions without creative efforts.

FIG. 5 is a schematic structural diagram of an electronic device according to an example implementation of this specification.

References are made to FIG. 5. At the hardware level, the electronic device includes a processor 501, an internal bus 502, a network interface 503, a memory 504, and a non-volatile memory 505, and certainly may further include other hardware needed by a service. The processor 501 reads a corresponding computer program from the non-volatile memory 505 to the memory 504 and then runs the computer program. Certainly, in addition to software implementations, this specification does not preclude other implementations, such as a logic device or a combination of software and hardware. In other words, an execution body of the following processing procedure is not limited to each logical unit, and may be hardware or a logic device.

The apparatus or unit illustrated in the foregoing implementations may be specifically implemented by using a computer chip or an entity, or may be implemented by using a product having a specific function. A typical implementation device is a computer, and a specific form of the computer may be a personal computer, a laptop computer, a cellular phone, a camera phone, a smartphone, a personal digital assistant, a media player, a navigation device, an email receiving and sending device, a game console, a tablet computer, a wearable device, or any combination of these devices.

In a typical configuration, the computer includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may include a non-persistent memory, a random access memory (RAM), a non-volatile memory, and/or another form that are in a computer-readable medium, for example, a read-only memory (ROM) or a flash memory (flash RAM). The memory is an example of the computer-readable medium. The one or more memory devices may be configured to individually or collectively store computer executable instructions for implementing the methods provided herein.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The computer-readable medium includes a persistent and a non-persistent, a removable and a non-removable medium, which implement information storage by using any method or technology. Information may be a computer-readable instruction, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a disk memory, a quantum memory, a graphene-based storage medium, another magnetic storage device, or any other non-transmission medium. The computer storage medium may be configured to store information that can be accessed by a computing device. Based on the definition in this specification, the computer-readable medium does not include transitory media (transitory media) such as a modulated data signal and carrier.

Some specific implementations of this specification are described above. Other implementations fall within the scope of the appended claims. In some cases, actions or steps described in the claims may be performed in a sequence different from that in some implementations and desired results can still be achieved. In addition, processes described in the accompanying drawings do not necessarily need a specific order or a sequential order shown to achieve the desired results. In some implementations, multi-tasking and parallel processing are also possible or may be advantageous.

After considering the specification and practicing the invention applied here, a person skilled in the art easily figures out other implementation solutions of this specification. This specification is intended to cover any variations, purposes, or adaptive changes of this specification. These variations, purposes, or adaptive changes follow the general principles of this specification and include common knowledge or conventional technical means in the art that are not applied in this specification. This specification and some implementations are merely considered as examples, and the actual scope and the spirit of this specification are pointed out by the claims.

It should be understood that this specification is not limited to the precise structures that have been described above and shown in the accompanying drawings, and various modifications and changes may be made without departing from the scope of this specification. The scope of this specification is limited by the appended claims only.

The foregoing descriptions are merely some example implementations of this specification, but are not intended to limit this specification. Any modification, equivalent replacement, or improvement made without departing from the spirit and principle of this specification shall fall within the protection scope of this specification.

1. A method for database operation, comprising:
in response to a received database request including a target database statement, obtaining an evolution task from a plan cache corresponding to the target database statement, wherein the evolution task is configured to compare performance of a first execution plan of a first type with performance of a second execution plan of a second type;
selecting a type of an execution plan actually used by the received database request based on that an accumulative quantity of execution times of each type of execution plan in an implementation process of the evolution task is positively correlated with performance of the type of execution plan; and
in response to it is determined that the performance of the first execution plan of the first type is better than the performance of the second execution plan of the second type, changing the first execution plan of the first type into an execution plan of the second type corresponding to the target database statement.

2. The method according to claim 1, further comprising:
in response to a received historical database request comprising the target database statement, querying a plan cache corresponding to the target database statement, and in response to the plan cache does not include a corresponding evolution task or a generated execution plan, generating a database statement execution plan corresponding to the target database statement; and
in response to the database statement execution plan is of the first type, generating the evolution task and caching the evolution task into the plan cache corresponding to the target database statement.

3. The method according to claim 1, further comprising:
in response to the received database request including the target database statement, querying a plan cache corresponding to the target database statement, and in response to the plan cache does not include a corresponding evolution task or a generated execution plan, generating a database statement execution plan corresponding to the target database statement; and
in response to the second execution plan of the second type corresponding to the target database statement exists, comparing the database statement execution plan with the second execution plan of the second type, and in response to a result of the comparison is that the database statement execution plan is consistent with the second execution plan of the second type, executing the database statement execution plan, and caching the database statement execution plan into the plan cache corresponding to the target database statement; and
in response to the second execution plan of the second type corresponding to the target database statement does not exist, classifying the database statement execution plan as an execution plan of the second type, executing the database statement execution plan, and caching the database statement execution plan into the plan cache corresponding to the target database statement.

4. The method according to claim 1, wherein the evolution task includes a plurality of stages, wherein:
in an initial stage of the plurality of stages, a quantity of execution times of the first execution plan of the first type is a same as a quantity of execution times of the second execution plan of the second type; and
in another stage of the plurality of stages other than the initial stage, a quantity of execution times of each type of execution plan is negatively correlated with a proportion of an average execution duration of the type of execution plan in at least one stage before the another stage.

5. The method according to claim 1, further comprises:
after implementation of the execution plan selected for the current database request is completed, determining whether the evolution task meets a evolution end condition, wherein the evolution end condition includes one or more of that a quantity of evolution times reaches a first threshold or an evolution duration reaches a second threshold; and
in response to the evolution end condition is met, terminating the evolution task.

6. The method according to claim 1, further comprising:
separately determining an average execution duration of the first execution plan of the first type and an average execution duration of the second execution plan of the second type based on an execution status of the evolution task; and
determining a relative performance between the first execution plan of the first type and the second execution plan of the second type based on their respective average execution durations.

7. The method according to claim 1, further comprising:
in response to an execution plan of the first type corresponding to the target database statement has not been used for a duration that reaches a duration threshold, deleting the execution plan of the first type.

8. An electronic device, comprising:
one or more processors; and
one or more memory devices, the one or more memory devices, individually or collectively, having processor-executable instructions stored thereon, the processor-executable instructions, when executed by the one or more processors, enabling the one or more processors to, individually or collectively, conduct actions including:
in response to a received database request including a target database statement, obtaining an evolution task from a plan cache corresponding to the target database statement, wherein the evolution task is configured to compare performance of a first execution plan of a first type with performance of a second execution plan of a second type;
selecting a type of an execution plan actually used by the received database request based on that an accumulative quantity of execution times of each type of execution plan in an implementation process of the evolution task is positively correlated with performance of the type of execution plan; and
in response to it is determined that the performance of the first execution plan of the first type is better than the performance of the second execution plan of the second type, changing the first execution plan of the first type into an execution plan of the second type corresponding to the target database statement.

9. The electronic device according to claim 8, wherein the actions further include:
in response to a received historical database request comprising the target database statement, querying a plan cache corresponding to the target database statement, and in response to the plan cache does not include a corresponding evolution task or a generated execution plan, generating a database statement execution plan corresponding to the target database statement; and
in response to the database statement execution plan is of the first type, generating the evolution task and caching the evolution task into the plan cache corresponding to the target database statement.

10. The electronic device according to claim 8, wherein the actions further include:
in response to the received database request including the target database statement, querying a plan cache corresponding to the target database statement, and in response to the plan cache does not include a corresponding evolution task or a generated execution plan, generating a database statement execution plan corresponding to the target database statement; and
in response to the second execution plan of the second type corresponding to the target database statement exists, comparing the database statement execution plan with the second execution plan of the second type, and in response to a result of the comparison is that the database statement execution plan is consistent with the second execution plan of the second type, executing the database statement execution plan, and caching the database statement execution plan into the plan cache corresponding to the target database statement; and
in response to the second execution plan of the second type corresponding to the target database statement does not exist, classifying the database statement execution plan as an execution plan of the second type, executing the database statement execution plan, and caching the database statement execution plan into the plan cache corresponding to the target database statement.

11. The electronic device according to claim 8, wherein the evolution task includes a plurality of stages, wherein:
in an initial stage of the plurality of stages, a quantity of execution times of the first execution plan of the first type is a same as a quantity of execution times of the second execution plan of the second type; and
in another stage of the plurality of stages other than the initial stage, a quantity of execution times of each type of execution plan is negatively correlated with a proportion of an average execution duration of the type of execution plan in at least one stage before the another stage.

12. The electronic device according to claim 8, wherein the actions further include:
after implementation of the execution plan selected for the current database request is completed, determining whether the evolution task meets a evolution end condition, wherein the evolution end condition includes one or more of that a quantity of evolution times reaches a first threshold or an evolution duration reaches a second threshold; and
in response to the evolution end condition is met, terminating the evolution task.

13. The electronic device according to claim 8, wherein the actions further include:
separately determining an average execution duration of the first execution plan of the first type and an average execution duration of the second execution plan of the second type based on an execution status of the evolution task; and
determining a relative performance between the first execution plan of the first type and the second execution plan of the second type based on their respective average execution durations.

14. The electronic device according to claim 8, wherein the actions further include:
in response to an execution plan of the first type corresponding to the target database statement has not been used for a duration that reaches a duration threshold, deleting the execution plan of the first type.

15. A computer-readable storage medium, wherein the computer-readable storage medium stores computer instructions, the instructions, when executed by one or more processors, enabling the one or more processors to, individually or collectively, implement actions comprising: in response to a received database request including a target database statement, obtaining an evolution task from a plan cache corresponding to the target database statement, wherein the evolution task is configured to compare performance of a first execution plan of a first type with performance of a second execution plan of a second type;
selecting a type of an execution plan actually used by the received database request based on that an accumulative quantity of execution times of each type of execution plan in an implementation process of the evolution task is positively correlated with performance of the type of execution plan; and
in response to it is determined that the performance of the first execution plan of the first type is better than the performance of the second execution plan of the second type, changing the first execution plan of the first type into an execution plan of the second type corresponding to the target database statement.

16. The computer-readable storage medium according to claim 15, wherein the actions further comprise:
in response to a received historical database request comprising the target database statement, querying a plan cache corresponding to the target database statement, and in response to the plan cache does not include a corresponding evolution task or a generated execution plan, generating a database statement execution plan corresponding to the target database statement; and
in response to the database statement execution plan is of the first type, generating the evolution task and caching the evolution task into the plan cache corresponding to the target database statement.

17. The computer-readable storage medium according to claim 15, wherein the actions further comprise:
in response to the received database request including the target database statement, querying a plan cache corresponding to the target database statement, and in response to the plan cache does not include a corresponding evolution task or a generated execution plan, generating a database statement execution plan corresponding to the target database statement; and
in response to the second execution plan of the second type corresponding to the target database statement exists, comparing the database statement execution plan with the second execution plan of the second type, and in response to a result of the comparison is that the database statement execution plan is consistent with the second execution plan of the second type, executing the database statement execution plan, and caching the database statement execution plan into the plan cache corresponding to the target database statement; and
in response to the second execution plan of the second type corresponding to the target database statement does not exist, classifying the database statement execution plan as an execution plan of the second type, executing the database statement execution plan, and caching the database statement execution plan into the plan cache corresponding to the target database statement.

18. The computer-readable storage medium according to claim 15, wherein the evolution task includes a plurality of stages, wherein:
in an initial stage of the plurality of stages, a quantity of execution times of the first execution plan of the first type is a same as a quantity of execution times of the second execution plan of the second type; and
in another stage of the plurality of stages other than the initial stage, a quantity of execution times of each type of execution plan is negatively correlated with a proportion of an average execution duration of the type of execution plan in at least one stage before the another stage.

19. The computer-readable storage medium according to claim 15, wherein the actions further comprise:
after implementation of the execution plan selected for the current database request is completed, determining whether the evolution task meets a evolution end condition, wherein the evolution end condition includes one or more of that a quantity of evolution times reaches a first threshold or an evolution duration reaches a second threshold; and
in response to the evolution end condition is met, terminating the evolution task.

20. The computer-readable storage medium according to claim 15, wherein the actions further comprise:
separately determining an average execution duration of the first execution plan of the first type and an average execution duration of the second execution plan of the second type based on an execution status of the evolution task; and
determining a relative performance between the first execution plan of the first type and the second execution plan of the second type based on their respective average execution durations.
